(19) United States
(12) Patent Application Publication
(10) Pub. No.: US 2024/0123478 A1
(43) Pub. Date: Apr. 18, 2024

(54) METHOD FOR RECYCLING ORE ENRICHMENT WASTE

(71) Applicants: Companhia Brasileira De Alumínio, São Paulo SP (BR); Universidade Federal De Viçosa – UFV, Viçosa, Minas Gerais (BR)

(72) Inventors: Christian Fonseca DE ANDRADE, Miraí Minas Gerais (BR); Ivo Ribeiro DA SILVA, Viçosa Minas Gerais (BR); Roberto SENO JUNIOR, Alumínio SP (BR); Nilson Gonçalves BIGOGNO, Miraí Minas Gerais (BR); Camila Botarro MOURA, Miraí Minas Gerais (BR)

(73) Assignees: Companhia Brasileira De Alumínio, São Paulo SP (BR); Universidade Federal De Viçosa – UFV, Viçosa, Minas Gerais (BR)

(21) Appl. No.: 18/286,586

(22) PCT Filed: Apr. 11, 2022
(86) PCT No.: PCT/BR2022/050129

§ 371 Date: Oct. 12, 2023

(30) Foreign Application Priority Data
Apr. 13, 2021 (BR) BR102021007039-0

(51) Int. Cl. B09B 3/21

(52) U.S. Cl. CPC B09B 3/21; B09B 2101/90

(57) ABSTRACT

The present invention relates to processes for recovering areas degraded by mining by means of soil treatment. In this context, the present invention provides a method for reusing ore concentrate waste, comprising the steps of (i) generating a solid or pasty residue from ore concentration, (ii) enriching the residue with at least two organic binders and a fertilizer to obtain an enriched/improved residue, (iii) depositing the enriched residue on the mined ground to form an enriched subsoil and (iv) depositing a topsoil layer on the enriched subsoil.

### FIELD OF THE DISCLOSURE

The present invention relates to methods for recovering areas degraded by mining. In particular, the present invention relates to methods of recovering areas degraded by mining by using waste to improve the subsoil.

### BACKGROUND OF THE INVENTION

The main environmental impacts directly associated with bauxite mining are: i) temporary disruption of the soil by the removal of topsoil in the preliminary stage (stripping) that precedes bauxite extraction; ii) removal of subsoil during ore extraction; iii) generation of silty-clayey tailings during ore washing and concentration.

The mitigation actions required after bauxite mining include: i) the need to treat the residual soil and its capacity to support the vegetation present in the pre-mining area by means of various environmental rehabilitation works, including the importance of reserving and using the topsoil, which is saved for later use in rehabilitating the land; ii) and aeration of the residual soil (mine bottom), enabling it to support root growth and also allow water to infiltrate.

The major challenge for the sustainability of this mining activity is to eliminate the generation of silty-clay waste that is deposited in sedimentation ponds (tailings dams). The risk of tailings dams collapsing has been a growing concern for society and supervisory bodies, mainly due to the accidents that took place in the Mariana region in 2015 and in Brumadinho in 2018, both in Minas Gerais. Therefore, a response consistent with the growing pressure from society for the mining sector to adopt increasingly sustainable practices necessarily requires both minimizing the volume of tailings produced during the processing and industrialization of ore, and constantly improving the rehabilitation of areas impacted during mining.

While significant progress has been made in restoring and rehabilitating areas mined for bauxite, obstacles remain in the operation that need to be cleared in order to make mining less impactful on the environment and more socially acceptable. It is known, for example, that for bauxite from the Zona da Mata, more than 50% of the raw ore mined and taken to the processing plant is composed mainly of soil, which after physical disintegration, washing and sieving of the bauxite, generates a dispersed silty-clayey tailings that is disposed of in a tailings dam. The useful life of this dam is inversely proportional to the amount of tailings fed into it and, therefore, it is in the interest of the useful life of the dam already commissioned to be as long as possible and, in an ideal situation, for the generation of tailings by washing the ore to be completely eliminated.

A specific technique that has been making headway in the mining market is the optimization of the bauxite concentration stages by subjecting the wash tailings to centrifugal dewatering. The waste from this concentration is a cake made up mainly of silt and clay, known as “clay cake”.

However, the state of the art has not disclosed a clay cake processing and utilization technique so as to provide a sustainable disposal of this material.

The present invention aims to solve the issues mentioned above in a practical and efficient way.

### SUMMARY

The main purpose of the present invention is to provide a method for reusing ore concentrate waste so that it can be used over the mined ground and, particularly in the subsurface, recreating a subsurface soil horizon, allowing the vegetation on the ground to be recovered more efficiently.

In order to achieve the objective described above, the present invention provides a method for reusing ore concentrate waste, comprising the steps of (i) generating a solid or pasty residue from the concentration of ore, (ii) enriching the residue with at least two binders and a fertilizer to obtain an enriched/improved solid residue, (iii) depositing the enriched residue on the waste rock at the bottom of the mine after its decompaction, before the topsoil is returned, in order to form an enriched subsoil and (iv) depositing a topsoil layer on the enriched/improved residue (subsoil) in order to recompose a soil profile with a sequence of horizons more similar to the original soil.

### BRIEF DESCRIPTION OF THE FIGURES

The detailed description below refers to the attached figures.

FIG. 1 shows a schematic sectional view of the mined plot depicting its various layers.

FIG. 2 shows a schematic sectional view of the mined plot on which an enriched waste has been applied directly to the mine tailings, before the topsoil is returned, according to a first embodiment of the method of the present invention.

FIG. 3 shows a schematic sectional view of the mined plot on which an enriched waste mixed with mine tailings has been applied, according to a second embodiment of the method of the present invention.

FIG. 4 shows a comparative graph of water retention capacity for an unenriched waste (clay cake) and an enriched waste.

FIG. 5 shows a comparative graph of aggregation capacity for an unenriched waste (clay cake) and an enriched waste.

FIG. 6 shows a graph of corn grain yield as a function of the dose of enriched waste applied to the subsurface of the mined plot.

### DETAILED DESCRIPTION OF THE INVENTION

Firstly, it should be noted that the following description is based on preferred embodiments of the invention. As will be evident to those skilled in the art, however, the invention is not limited to these particular embodiments.

The present invention provides a method for reusing ore concentrate waste, but it can be used to reuse other types of fine tailings from any mining operation. In a first step of the method of the present invention, a solid or pasty residue is generated from the concentration of ore. Preferably, this residue, called “clay cake”, is generated from the centrifugal dewatering of the ore washing tailings.

The clay cake, which in the case of bauxite mining is basically made up of 70% silt and clay, is preferably enriched with binders and/or fertilizers to obtain an enriched and chemically and physically improved residue. Fertilizers for enriching the clay cake can be organic, chemical and/or mineral, and at least two binders can be organic binders (different sources of labile and recalcitrant C), in order to enable the continued production of cementing agents that will facilitate its coagulation and the start of the particle reaggregation process during its preparation and after its application in the mined areas and in the rehabilitation phase.

Studies carried out under controlled conditions have shown the importance of incorporating, in addition to fertilizers and correctives, organic compounds with high lability, to quickly reactivate the soil microbiota, and organic compounds with low lability, to immediately increase the porosity and water permeability of the cake. The enriched residue, by enabling microbial activity and root growth, will enable the reformation of water-stable aggregates and soil structure in the medium and long term. The components and quantities to be used will depend on the characteristics of the clay cake, the type of plant to be used in the rehabilitation of the mined area, and the availability and cost of organic binders in the mine region.

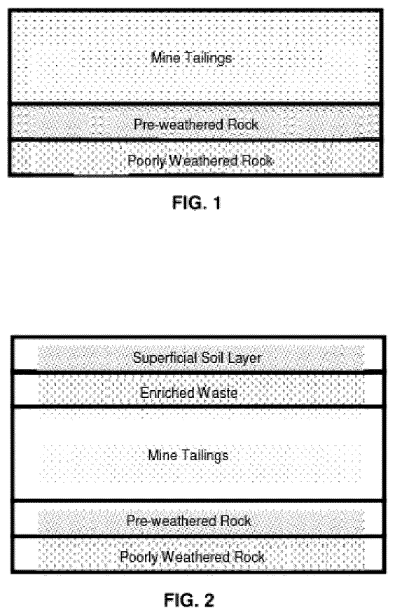

The enriched waste is then deposited on top of the mined ground, on top of the uncompacted waste rock before the topsoil is returned to form an enriched subsoil. The mined ground preferably comprises at least three layers, namely (i) poorly weathered rock at the bottom; (ii) pre-weathered rock, above the poorly weathered rock; and (iii) mine tailings, above the pre-weathered rock, as shown in FIG. 1.

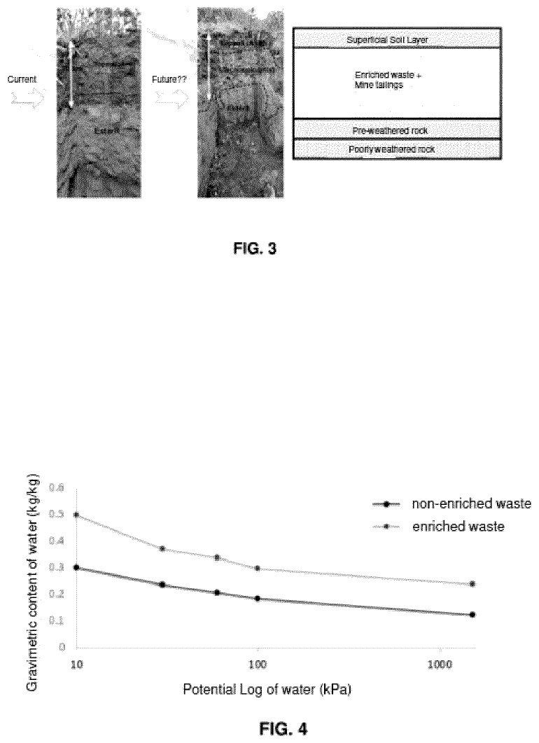

The enriched waste can be deposited directly on top of the mine tailings, as shown in FIG. 2. Alternatively, the enriched waste can be mixed with at least part of the mine tailings to be deposited directly on top of the rest of the mine tailings or directly on top of the pre-cracked rock, as shown in FIG. 3.

Once the enriched waste has been deposited underground, either with the enriched waste on top of the mine tailings (FIG. 2) or mixed with (FIG. 3), a topsoil layer is deposited on top of the enriched subsoil. The superficial layer of soil, also known as topsoil, preferably comprises corrected soil, prepared with fertilizers (organic and mineral) and correctives for planting vegetation. As already mentioned in the description of the prior art, the topsoil is removed when the land is mined and reserved for later covering of the mined area.

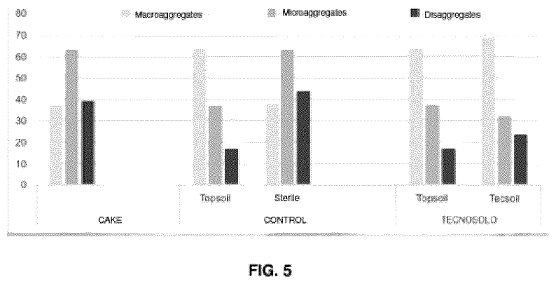

The tests carried out showed a considerable increase in the water retention capacity and aggregation of the enriched residue when compared to the clay cake (untreated residue), as shown in FIGS. 4 and 5.

In addition, a corn planting experiment was carried out in an area previously mined for bauxite using different doses of enriched residue in subsurface areas, according to table 1 below.

TABLE 1

| | Dose of enriched waste (t/ha) | Corn grain yield (kg/ha) |
|---|---|---|
| Area 1 | 0 | 4845 |
| Area 2 | 600 | 6058 |
| Area 3 | 1500 | 6488 |
| Area 4 | 3000 | 8009 |

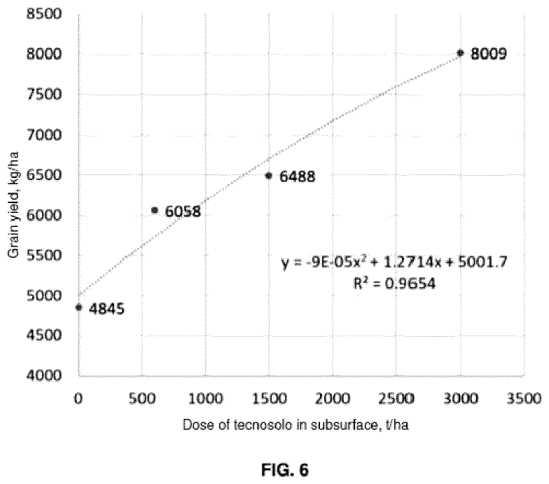

The residue used in this experiment came from bauxite processing. It was observed that grain yield increased in a curve-shaped manner with the dose of enriched waste used in each area. FIG. 6 shows a chart with the data presented on table 1.

The productivity of Area 1, obtained in the treatment without enriched waste, would be that obtained in rehabilitation conditions according to prior art, with topsoil returned directly on the mine tailings. The maximum productivity achieved in Area 4 was 8009 kg/ha, which is well above the national average productivity and represents almost double the productivity in Area 1, which represents the state of the art of the present invention. These productivity responses show that the present invention can improve plant growth in mined areas undergoing rehabilitation, as well as providing a more economical and environmentally sustainable destination for ore processing waste.

Numerous variations affecting the scope of protection of the present application are permitted. This reinforces the fact that the present invention is not limited to the particular configurations/embodiments described above.

1. Method for reusing ore concentrate waste, characterized in that it comprises the stages of:
generating a solid or pasty residue from the ore concentrate;
enriching the waste with at least two binders and a fertilizer to obtain an enriched waste;
mixing the enriched solid waste with mine tailings;
depositing the enriched waste on the mined land to form an enriched subsoil; and
depositing a topsoil layer on top of the enriched subsoil.

2. Method according to claim 1, characterized in that the step of depositing the enriched solid waste is carried out on the mine tailings.

3. (canceled)

4. Method according to claim 1, characterized in that the topsoil comprises a corrected soil.

5. Method according to claim 1, characterized in that the at least two binders are two organic binders (distinct sources of labile and recalcitrant C), and the fertilizer is an organic or mineral fertilizer.
